(19) United States
(12) Patent Application Publication
(10) Pub. No.: US 2023/0392640 A1
(43) Pub. Date: Dec. 7, 2023

(54) METHOD FOR PRODUCING A PRESS-IN CONNECTION, PRESS-IN CONNECTION AND FASTENING ELEMENT

(71) Applicant: Richard Bergner Holding GmbH & Co. KG, Schwabach (DE)

(72) Inventor: Süleyman KAHRAMAN, Osmangazi Bursa (TR)

(21) Appl. No.: 18/236,086

(22) Filed: Aug. 21, 2023

Related U.S. Application Data
(63) Continuation of application No. PCT/EP2022/053915, filed on Feb. 17, 2022.

(30) Foreign Application Priority Data
Feb. 22, 2021 (WO) PCT/IB2021/000112

(51) Int. Cl. F16B 37/06

(52) U.S. Cl. CPC F16B 37/068

(57) ABSTRACT

A method of producing a press-fit connection and to such a connection between a component and a fastening element. A head of the fastening element is pressed into an unpunched component without piercing it. A form fit acting in the axial direction is formed between the head and the component by material forming. For low press-in forces, the head has a central area projecting in the axial direction.

This nonprovisional application is a continuation of International Application No. PCT/EP2022/053915, which was filed on Feb. 17, 2022, and which claims priority to International Patent Application No. PCT/IB2021/000112, which was filed on Feb. 22, 2021, and which are both herein incorporated by reference.

### BACKGROUND OF THE INVENTION

### Field of the Invention

The present invention relates to a method of producing a press-fit connection between a fastening element and a metallic component, as well as to such a press-fit connection and to a fastening element for such a press-fit connection.

### Description of the Background Art

Fastening elements such as screws, nuts, bolts, etc. should be permanently attached to components such as sheet metal, extruded profiles or castings in many branches of industry. Particularly in the automotive industry, which manufactures very complex products or partial products, there are special requirements for a secure, permanent press-fit connection between a fastening element and metallic components. In this respect, two technologies generally play an important role in permanently joining a fastener to a component such as a sheet metal. These technologies are welding and mechanical fastening technology, specifically the production of a press-fit connection in which a press-fit element is pressed into a component and held there permanently.

In welding processes, the fastener and the sheet metal are permanently joined together by melting certain areas of both components by applying heat, so that a material bond is formed between the fastener and the sheet metal.

Self-clamping fasteners, hereinafter referred to as fasteners, are frequently used in mechanical fastening technology with press-fit elements. In this method, a hole is often made in the sheet metal and the press-fit element is placed in this hole. During the press-fit process, a force is exerted that results in plastic deformation of the sheet metal or the press-fit element itself, or both components. As a result of the plastic deformation, a permanent form fit is produced between the fastening element and the sheet. An example of this is described in EP 1 704 334 B1, which corresponds to US 2007/098520. Such press-fit connections are further known, for example, from WO 2017/084 745 A1, U.S. Pat. No. 7,160,072 B2, WO 01/03881 A1 (which corresponds to U.S. Pat. No. 6,994,486) or DE 199 49 161 B4. With these known solutions, there is often the problem that the underside of the component is not flat and that in some cases complex dies are required.

Press-fit processes sometimes disadvantageously require a hole to be made in the component as a first step. As a result, the joint is often not gas-tight, especially if there are high pressure differences between the top and bottom of the sheet. Additional sealing elements must therefore be used for sealing.

A further disadvantage is that after mechanical joining, parts of the fastening element and/or the sheet often protrude on both sides of the sheet and there is no flat sheet side on one side to ensure gas tightness. This can lead to restrictions in the design if, for example, two adjacent components are to be placed as close to each other as possible.

### SUMMARY OF THE INVENTION

It is therefore an object of the present invention to provide a connection between a fastening element and a component which is gas-tight and in which a head region of the press-fit element does not protrude beyond one side of the component.

The task is solved according to an exemplary embodiment of the invention by a method for producing a press-fit connection between a fastening element, in particular a press-fit bolt, and a component, in particular a metal sheet, wherein the fastening element has a head and is pressed into the component with the head first by means of a punch without piercing the component. In this process, material of the component is first displaced by the head, in particular radially outwardly, at least and preferably only part of the displaced material being pressed radially against the head by the punch, so that a form fit in the axial direction is formed between the material pressed against the head and the head.

The task is further solved by such a press-fit connection and a fastening element used therefor. The advantageous embodiments listed below with regard to the method, the press-fit connection and the fastening element can also be applied to the other two categories.

The material formed by the punch and the form fit thus produced ensure a permanent connection.

Since the fastening element does not pierce the component, there is also no risk of leakage. The component is not pre-punched, so that the underside of the component opposite the fastening element is not damaged. This ensures tightness and the press-fit connection is gas-tight. No additional sealing measures, such as a gasket, and also no leak test are required or provided.

The fastening element can be inserted directly into the (ductile) component, in particular sheet metal, without any pretreatment of the component, such as hole forming or a forming process.

Preferably, a protrusion on the underside of the typically thin component is further avoided, i.e. the underside of the component also remains undeformed, i.e. it is not deformed during the press-fit process. In particular, the underside is flat. Therefore, this method offers a solution for tight and restricted geometries.

The fastening element may be designed overall as a press-fit element, which is thus pressed into the component by an appropriate press-in force as described. In particular, the fastening element is a bolt-shaped element, i.e. either a bolt, a screw, a pin, a rivet, etc. The bolt-shaped element has a shank with the head adjoining it at the end. Alternatively, the fastening element is, for example, a nut with an internal thread.

The head can have a head side oriented towards the component, which has a center region projecting in the axial direction. During the press-fit process, the head is initially pressed against the component with this central region and, starting from the center region, the material of the component is displaced radially outwards during the further press-fit process. This geometry with the protruding center region advantageously reduces the required press-in force. Accordingly, the press-in tools, such as punches and a drive for applying the press-in force, can be more compactly dimensioned. Process reliability is also increased as the protruding center region displaces the material of the component to the outside in a controlled and defined manner.

In the present case, the axial direction can also be the press-in direction and the longitudinal direction of the fastener along a central axis starting from the shaft in the direction of the head.

The head side can be convexly curved. It may therefore be arc-shaped when viewed in cross-section and runs in particular along an arc segment. In particular, it forms a convexly curved surface. In particular, the head side is lenticular.

As an alternative to this convexly curved surface, the head side can be formed by several flat surfaces and, for example, in a faceted manner. It is formed, for example, in the manner of a pyramid or a truncated pyramid. A conical design is also possible.

Anti-rotation elements can also be formed on the head, which form a positive fit with the material of the component acting in the circumferential direction. The head therefore has a dual function and, in the pressed-in state, provides both axial pull-out protection and anti-rotation protection. The anti-rotation elements are either elements projecting from the head or indentations. These are arranged around the circumference, in particular uniformly distributed. For example, 3-10 and in particular 4-8 anti-rotation elements are formed.

The anti-rotation elements can be formed on the head side, in particular as several radial ribs. As an alternative to the ribs, the anti-rotation elements are formed, for example, as radial notches or grooves.

The press-fit elements formed on the head side may extend only in a radially outer region of the head side, so that no anti-rotation elements, in particular no ribs, are formed in a central region of the head side, especially in the projecting central region with which the head side first strikes the component during the press-fit process.

The anti-rotation elements can be formed around the peripheral edge of the head. In this case, they can be specifically formed as indentations, for example as concavely curved indentations. The indentations have, for example, a partially cylindrical wall.

With regard to the desired flat underside of the component, an anvil can be provided as an abutment during the press-fit process, which has a flat bearing surface. The contact surface is flat throughout and has no depressions, elevations or openings. The anvil thus forms a die with a continuously flat bearing surface without depressions, elevations or openings. During the press-fitting process, the underside of the component rests on this flat bearing surface. This ensures that deformation of the underside is avoided during the press-fitting process.

A special design of the punch can be provided for the reliable positive connection of the fastening element to the component. The punch has a radially inner press ring with which it is pressed against a press surface formed on a head underside of the head and exerts the required axial press-in force via this. The punch is in particular a hollow punch with an inner cavity for receiving the shaft of the bolt. The press ring is formed on the end face and runs around the inner cavity in an annular shape. The pressing surface is designed in particular to correspond to this. In particular, it is also annular. In particular, a shoulder projecting in the direction of the shank is formed on the underside of the head, the end face of which forms the annular pressing surface. This is aligned horizontally in particular, as is the end face of the press ring.

In addition to the pressing surface, the punch also can have a forming section arranged radially further out, with the aid of which the material initially displaced radially outwards by the head is pressed again in the radial direction towards the head and in particular towards the shank. In particular, this forming section is directly adjacent to the pressing surface. It is preferably inclined in the direction of the shank and thus in the direction of the inner cavity, so that a circumferential inclined forming surface is formed which exerts a radial force component on the material of the component in the direction of the inner cavity and thus of the shank. Viewed in cross-section, this circumferential surface is either rectilinear and thus conical or also curved. In particular, the forming surface is designed in the manner of a conical surface.

The punch can have a cutting ring at its front end, which can be sharp-edged or alternatively rounded. With this, it cuts into the surface of the component and especially into the material displaced to the outside during the press-fit process. The cutting ring forms the radially outer end of the forming section, i.e. it adjoins it in the radial direction. To form this cutting ring, the forming surface described above encloses an acute angle with an outer lateral surface of the punch, which is designed in particular as a cylindrical lateral surface. This lies, for example, in the range between 300 and 600.

The head geometry of the head and the geometry of the punch can be matched to each other in such a way that material of the component is first displaced radially outward during the press-fit process before the forming section reaches the component surface.

The head can have an axial height that is greater than the axial extension of the punch from the press ring to the axially foremost partial area of the punch, which is formed in particular by the cutting ring. The axial height of the head is defined by the axial distance between the pressing surface and the foremost section of the head.

With regard to axial pull-out protection, the head as a whole has a circumferential, radially outwardly projecting pull-out surface. This adjoins the shoulder described above in particular in the radial direction. The shoulder generally has the aforementioned pressing surface on its end face as well as a cylindrical lateral surface extending in the axial direction. The pull-out surface is therefore generally offset from the shoulder and in particular from the pressing surface.

During the pressing-in process, the punch presses the material initially displaced by the head radially inwards again and over the pull-out surface, so that the form fit acting in the axial direction is formed. The material is only pressed over the pull-out surface. Preferably, a clearance is left to the lateral surface of the shoulder. In general, therefore, the head has two subregions, namely a first subregion oriented towards the shank, which is formed by the shoulder, and a second subregion facing away from the shank, which projects radially beyond the first subregion and thus serves to secure the axial pullout, and which also has the front, end side of the head with the forwardly projecting central region. Preferably, the anti-rotation elements are also formed on this second partial region. Preferably, the shoulder has only smooth surfaces. For example, it is designed overall as a circular ring cylinder with a smooth peripheral surface and a flat pressing surface.

The method as a whole can be characterized by the following steps, which may follow one another in the order mentioned:
i. Exertion of a force on the punch,
ii. jointly feeding the punch and fastener to the component while simultaneously applying a force,
iii. plastic deformation of the component by the head of the fastener, in particular by the protruding center region,
iv. formation of a material bead (material accumulation) around the head formed of plastically deformed material of the component due to the head penetrating the component,
v. contact of the deformed material with the forming section,
vi. displacing the deformed material toward an pull-out surface and against the anti-rotation elements using the forming section of the punch,
vii. overlapping and pressing the deformed material against the pull-out surface to form the form fit acting in the axial direction,
viii. creating anti-rotation through the anti-rotation elements.

The press-fit connection formed in this way between the fastening element and the component is characterized firstly by the fact that the component is not perforated and is also preferably not otherwise pretreated. The fastening element is pressed into the component with its head first, without piercing the latter, and the material plastically displaced by the head during the pressing-in process is formed again in the direction of the head and thus forms a tight fit with the head.

The head can have a frontal head side with a protruding central region, which is in particular lenticular in shape.

The component can be flat and level on its underside opposite the fastening element, i.e. it has no bulge or other deformation.

The fastening element can be provided for such a press-fit connection and for such a process is characterized in particular by the fact that its head has a protruding central region. The head side is in particular lenticular in shape. Viewed in cross section, the head side runs in particular along a radius.

The fastening element also have the anti-rotation elements described above, which are formed on the head. In particular, the anti-rotation elements are formed on the head side, i.e. on the end face of the fastening element. They are specifically formed as ribs or notches that extend in the radial direction. Alternatively, anti-rotation elements, in particular in the form of indentations, are formed on the head circumference.

The fastening elements may extend only in an outer radial region of the head side and do not extend straight to the center. In the central area, the head side is therefore free of anti-rotation elements.

Particularly in the design of the ribs, it can be provided that these do not protrude in the axial direction beyond the central region of the head side. This ensures that during the press-fitting process, the head initially strikes the surface of the component with the protruding central region and the plastic deformation is unaffected by the anti-rotation elements.

The axial extent of the anti-rotation elements, i.e. an axial height in the case of ribs and an axial depth in the case of notches, varies in the radial direction and increases continuously in particular. In the case of ribs, the increase takes place from the inside to the outside. In the case of notches or grooves, the reverse is true.

Furthermore, it is provided in particular that a front end face of the ribs facing away from the head side or a groove base of the notches runs horizontally, i.e. perpendicular to the axial direction.

It can also be further provided that the end faces of the ribs or the respective groove bottoms of the notches run within a common (horizontal) plane.

This measure achieves a good overall anti-rotation effect without the initial plastic deformation process being influenced by the anti-rotation elements when the center region is impacted.

The fastening element can be designed as a bolt-shaped element with a shank to which the head is connected at the end, the head having a head underside opposite the head side, on which a shoulder is formed which is directly connected to the shank in the radial direction and which forms a pressing surface for transmitting an axial press-in force, a pull-out surface also being connected to the shoulder in the axial and radial directions. This design ensures process-reliable press-fitting with reliable axial pull-out protection.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view in the manner of an exploded view showing a fastening element, a component, and a punch and an anvil;

FIG. 2 is a side view of the fastening element according to a first variant;

FIG. 3 is a top view of the fastening element according to FIG. 2;

FIG. 4 is a perspective view of the fastening element according to FIG. 2;

FIG. 5 is a top view of the situation during the press-fit process;

FIG. 5A is a sectional view according to line 5A-5A in FIG. 5 through the fastener, the component, the punch and the anvil at the beginning of the press-fit operation;

FIG. 5B is a detailed view of area 5B in FIG. 5A;

FIG. 6 is a sectional view like FIG. 5A at a later stage of the press-fit process;

FIG. 7 is a sectional view like FIG. 5A at an even later stage of the press-fit process;

FIG. 8 is a detailed view of area 8 in FIG. 7;

FIG. 9 is a perspective view of a sheet with a press-fit element attached to it;

FIG. 10 is a side view of the arrangement according to FIG. 9;

FIG. 11 is a top view of the arrangement shown in FIG. 9;

FIG. 12 shows perspective views of the fastening element according to a second variant;

FIGS. 13A and 13B are perspective views of a fastener according to a third variant in which ribs are formed on a frontal head side; and

FIGS. 14A to 14C are sectional views illustrating various steps for making the press-fit connection.

### DETAILED DESCRIPTION

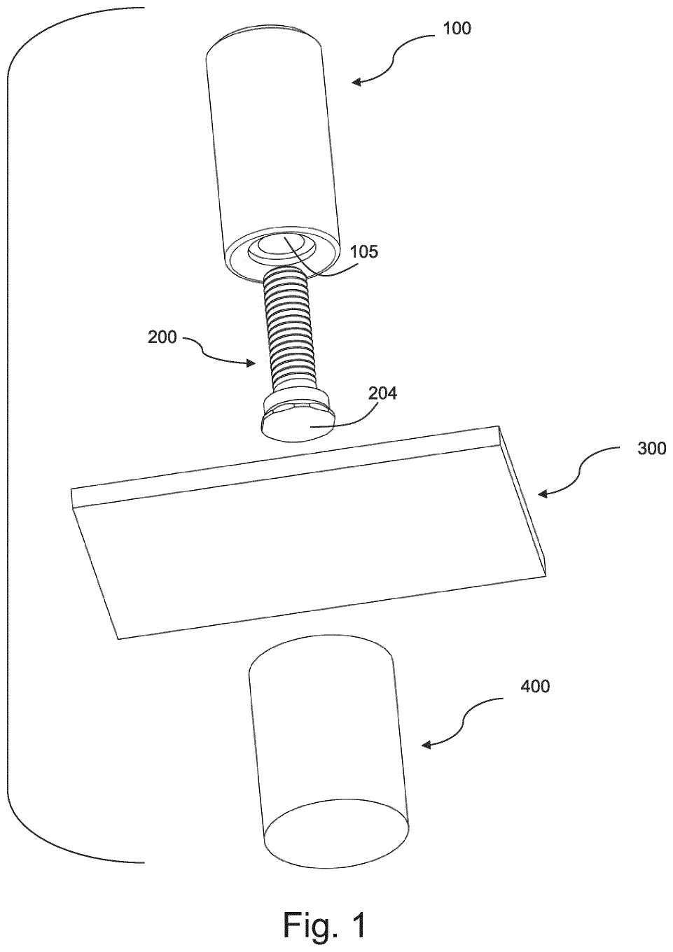

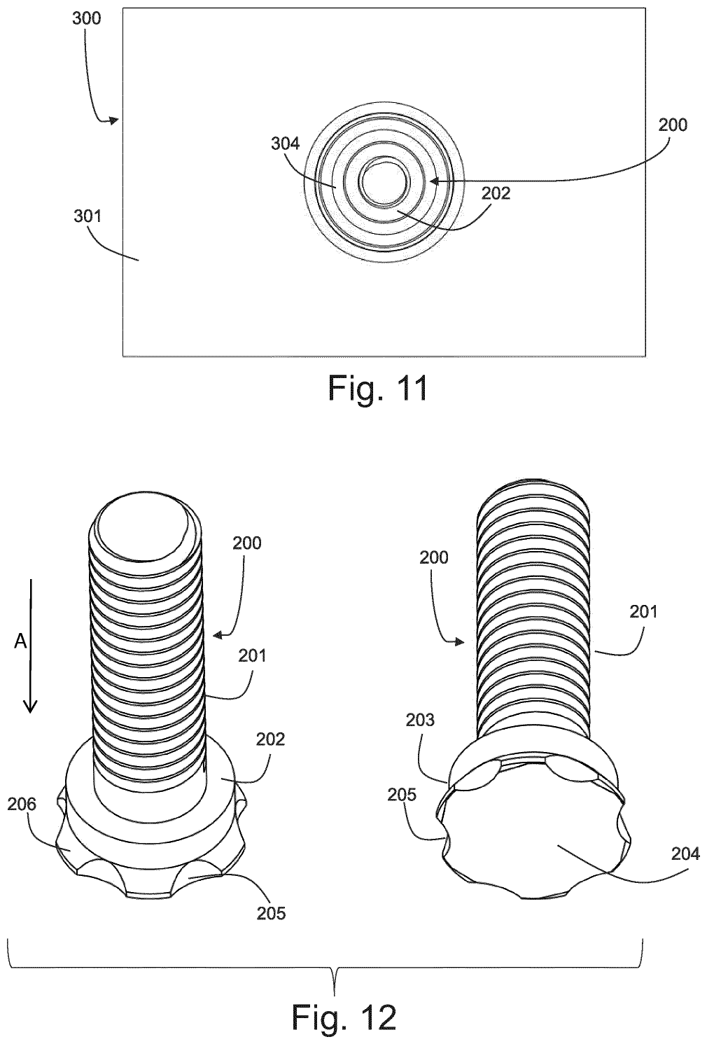

FIGS. 1-14 illustrate the method of making a press-fit connection between a fastener 200 and a ductile member, namely a sheet 300.

FIG. 1 shows the components used to form the press-fit connection without pre-punching. These components are a punch 100, the sheet 300, the fastening element 200, which is designed in particular as a screw, and an anvil 400.

In the embodiment, the punch 100 is cylindrical and has an inner cavity 105. The punch 100 extends in an axial direction A along which the fastener 200 also extends and along which it is pressed into the sheet 300. During the press-fitting process, a shank 201, in the embodiment a threaded shank, is received by the inner cavity 105 and pressed together with the punch 100 into the sheet 300 and against the anvil 400 arranged thereunder.

The fastening element 200 has a head 207 with a front head side 204 that is curved forward in the axial direction A, i.e., toward the side facing away from the shaft 201, and thus forms a protruding center region there. Specifically, the head side 204 has a front radius. With this, i.e. with the protruding central region, the fastening element 200 comes into contact with the sheet metal 300 for the first time.

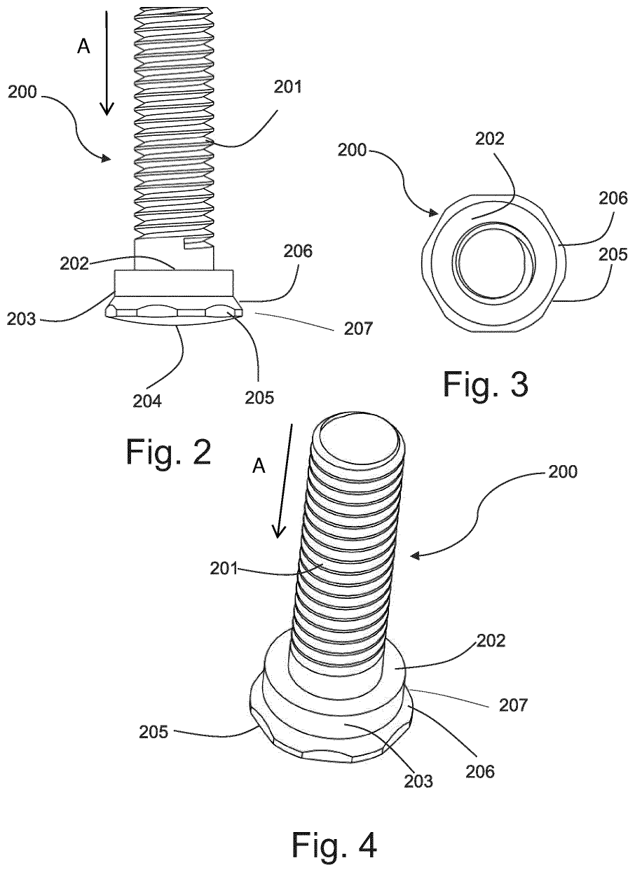

FIGS. 2-4 show various views of the fastener 200. The threaded shank is used for releasable fastening with another fastener (in this case, for example, a nut). Major geometric details of the fastener 200 can be seen in FIGS. 2-4.

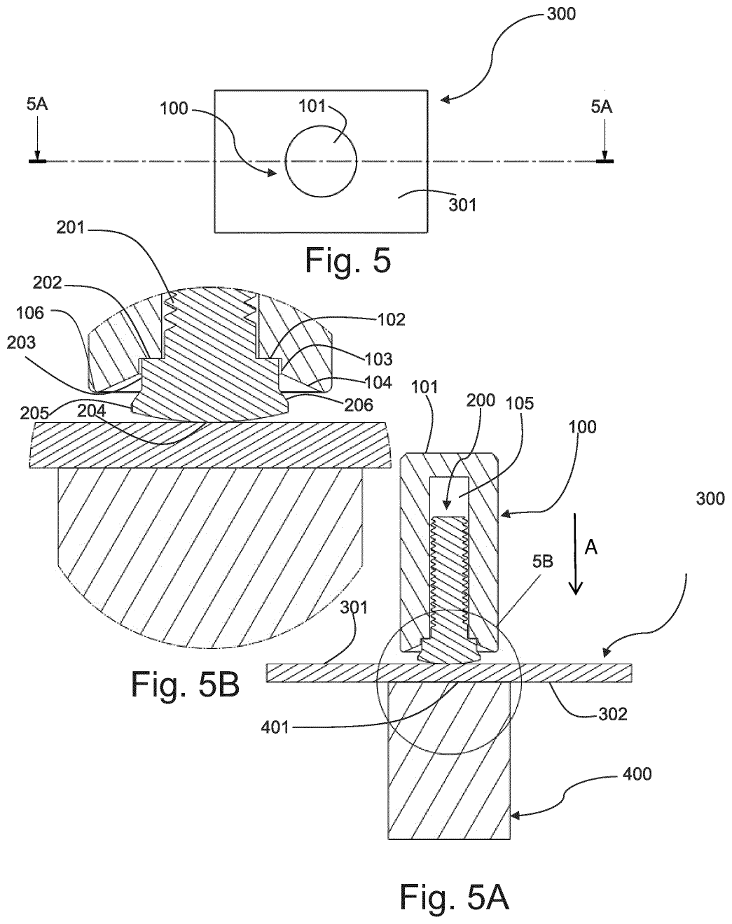

Starting from the head 207, the shank 201 is connected in the opposite direction to the axial direction A. The head 207 has a shoulder 203 running annularly around the shaft 201, which forms an annular pressing surface 202 opposite the head side 204. The side of the head 207 opposite the head side 204 and facing the shaft 201 is generally referred to as the head underside. The pressing surface 202 serves as a punch contact surface, i.e. during the press-fit process the punch 100 is supported by a corresponding press ring 102 (compare for example FIG. 5B) for transmitting the axial press-fit force. The press ring 102 therefore forms a corresponding contact surface.

The circumferential side of the shoulder 203 is cylindrical in the shown embodiment. Adjacent to this shoulder 203 is a second partial region of the head 207, which widens radially outwardly starting from the shoulder 203. In particular, this second partial region widens conically and has an obliquely outwardly inclined pull-out surface 206, which is formed in the manner of a cone surface. The head side 204 adjoins this pull-out surface 206 at the end face. The pull-out surface 206 serves to form a rear grip with a formed material region of the sheet 300 and thus to form the axial pull-out protection, as will be explained in more detail below, in particular in connection with FIGS. 5A and 5B.

Therefore, the underside of the head opposite the head 204 forms both the pull-out surface 206 and the pressing surface 202.

Circumferentially around the periphery of this second portion of the head 207, a plurality of anti-rotation elements 205 are provided in the form of bulges. These extend in the radial direction only a short distance in the direction of the shaft 201, in such a way that they are spaced from the circumferential lateral surface of the shoulder 203.

In the second embodiment, as shown in FIG. 12, these protrusions extend to the peripheral shell surface of the shoulder 203.

As an alternative to the bulges, flattenings can also be formed.

Generally, a plurality of anti-rotation elements 205 are provided evenly distributed around the circumference, specifically 3-8 and in the specific embodiment 6.

Of particular importance for the design of the press-fit connection is the special head geometry, in particular with the projecting central region on the head side 204 and with the stepped design of the head 207 with the subdivision into two subregions, namely on the one hand with the shoulder and on the other hand with the second subregion extending radially outwards with the pull-out surface 206 and the anti-rotation elements 205 arranged in this second subregion.

Based on the top view according to FIG. 5, it can be seen that the punch 100 has a force receiving surface 101 on its upper side in the embodiment example, on which the press-in force is exerted during the press-in process by means of a suitable drive. Alternatively, a punch 100 without (in particular flat) force receiving surface 101 is used. This is particularly suitable for use in automated production systems, such as those used in presses or stationary or mobile joining units. In this case, the fastening element 200 is fed to the punch 100 from above, for example via a feed hose or a feed line. In this case, the punch 100 typically has an annular force-receiving surface.

With reference to FIG. 5B, the special frontal configuration of the punch 100 can be seen. Thus, also in the manner of a shoulder formed at the end of the cavity 105, this has an annular surface which forms the already mentioned press ring 102. This rests on the corresponding pressing surface 202 during the pressing-in process. The press ring 102 and the press surface 202 have substantially the same radial extent. The annular surface of the press ring 102 is adjoined by a cylindrical jacket section extending in the axial direction A, which at least partially accommodates the shoulder 203.

At the end of this jacket section, the punch 100 has an oblique and radially outwardly extending surface, in particular in the shape of a conical shell, which forms a forming section 104. This extends up to an outer press-fit ring, which is designed, for example, as a cutting ring 106. The edge of the ring is rounded, for example, as shown in FIG. 5B, or sharp-edged, as shown in FIGS. 14A to 14C. The press-fit or cutting ring 106 defines the foremost surface of the punch 100 with which it first strikes the sheet 300.

The axial length starting from the annular surface of the press ring 102 to this cutting ring 106 is less than the axial length of the head 207 and preferably extends only to the end of the shoulder 203.

The sheet 300 has an upper surface 301 facing the fastener 200 and an opposite lower surface 302.

The anvil 400 has a flat support surface 401 oriented upward toward the sheet 300, which is designed to be planar throughout. It therefore has, in particular, no depression or elevation.

The press-fit process begins with the application of a force to the punch 100, for example to the (planar) force receiving surface 101 shown or alternatively to an annular force receiving surface. The application of the force causes the punch 100 and the fastening element 200 to penetrate the deformable sheet 300 together. The sheet 300 supports itself with its underside 302 on the support surface 401 of the anvil 400.

During the pre-stroke of the punch 100, the protruding central region of the head side 204 first comes into contact with the upper side 301 of the component 300. Of particular importance here is that, due to the protruding central region, there is only slight surface contact, in particular only point contact, between the head side 204 and the sheet 300 at the start of the plastic forming process, so that a very high surface contact pressure force is exerted.

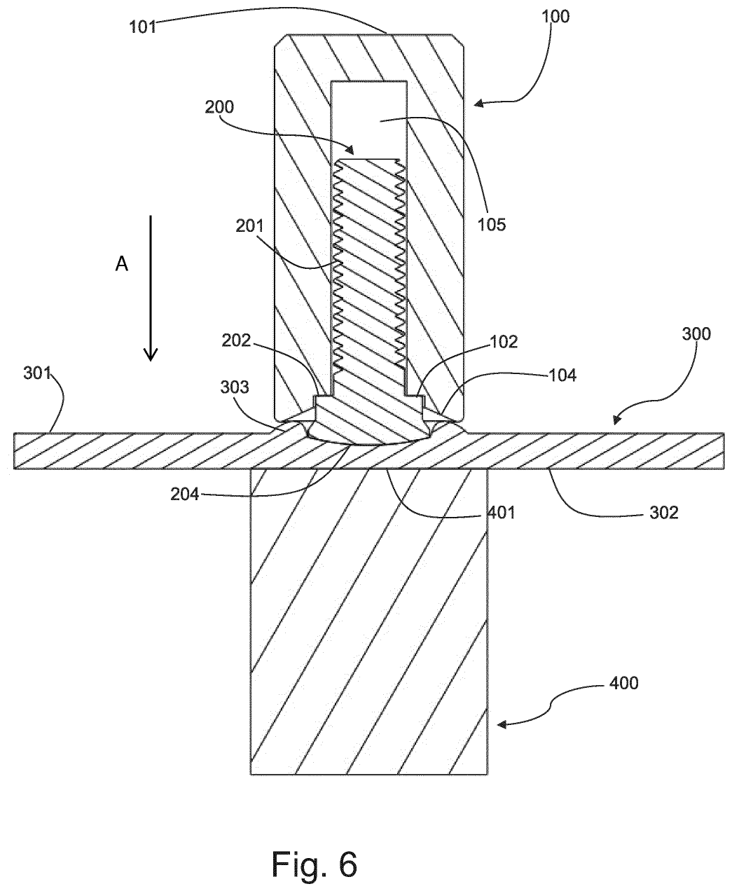

At the same time, the special shape of the head 204 with the radially outwardly receding surface areas causes a defined and targeted plastic deformation and displacement of the material from the upper side 301 of the sheet 300. This results in an annular material bead 303 formed of plastically deformed/displaced sheet material forming circumferentially around the head 207 in the direction of the shoulder 203. This situation shown in FIG. 6 therefore represents an intermediate stage in the typically continuous press-fit process. In this intermediate stage, the material is initially only partially deformed.

In a subsequent final stage of the press-fit process, this material bead 303 is finish-formed. The cutting section 106 engages in this formed material bead 303. The forming section 104 then presses material from the formed material bead 303 in a radial direction back toward the head 207. In the process, a closing bead 304 is formed, as can be seen in particular in FIG. 8. This closing bead 304 is pressed against the pull-out surface 206, so that a kind of press fit is formed. For reliable pull-out protection, a positive undercut is formed between the pull-out surface 206 and the closing bead 304.

This press-fitting process can be easily understood again from FIGS. 14A to 14C. In this embodiment, a punch 100 is used in which the cutting ring 106 has a sharp edge. This preferably has a triangular profile at least in its front region facing the sheet 300. In this embodiment, the forming section 104 is formed in profile as a curved surface, namely a concavely curved surface. In principle, such a curved forming section 104 can also be provided in the first embodiment variant, as shown for example in FIGS. 5-8. This convexly curved forming section has a favourable effect on forming. Especially also in combination with the sharp-edged cutting ring 106, only low press-in forces and forming forces are required overall due to the selected punch geometry according to FIGS. 14A to 14C.

Moreover, when the material is plastically deformed, the anti-rotation means is also formed simultaneously, in that the plastically deformed material forms a form fit with the anti-rotation elements 205 that is effective in the circumferential direction.

In particular, no deformation of the fastening element 200 occurs in the process described here.

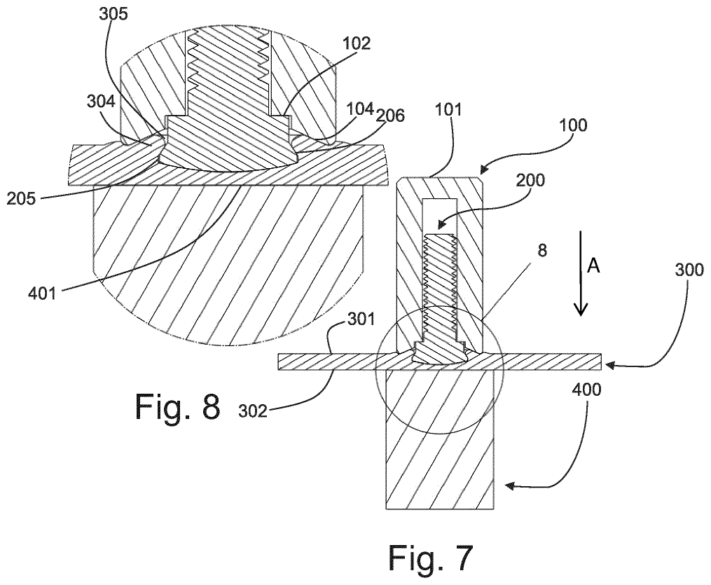

Due to the special punch geometry and due to the special process described herein with the deformation of the formed material bead 303, into which the cutting area 106 cuts, the upper side 301 of the sheet 300 has a characteristic geometry, as can be seen in particular from FIGS. 7-11. Namely, initially an annular and concentrically circumferential groove is formed by the cutting ring 106. Radially inwardly adjoining this groove is the closing bead 304 rising from a normal level of the upper surface 301. Adjacent to the annular groove, viewed in a radially outward direction, a remaining residual bead is usually also formed, which also rises above the normal level of the upper side 301, i.e. the level in the initial state.

Furthermore, it should be emphasized that the underside 302 of the sheet 300 does not undergo any deformation and, in particular, is formed flat throughout in the region of the fastening element 200.

As can be seen in particular from FIG. 8, in a preferred embodiment a free space 305 is formed between the peripheral side of the head 207 and the closing bead 304, so that the closing bead 304 is spaced from the lateral surface of the shoulder 203. Depending on the components selected, this free space 305 may also be closed.

The force required to produce deformation of the ductile sheet 300 increases steadily throughout the press-fit process. In particular, this force increases dramatically from the intermediate stage with the partially formed material and the material bead 303 (shown in FIG. 6). Depending on the strength of the sheet metal, the clearance 305 between the closing bead 304 and the lateral surface of the shoulder of the fastener 200 may change. The minimum requirement for the press-fit operation is that the closing bead 304 overlaps the pull-out surface 206.

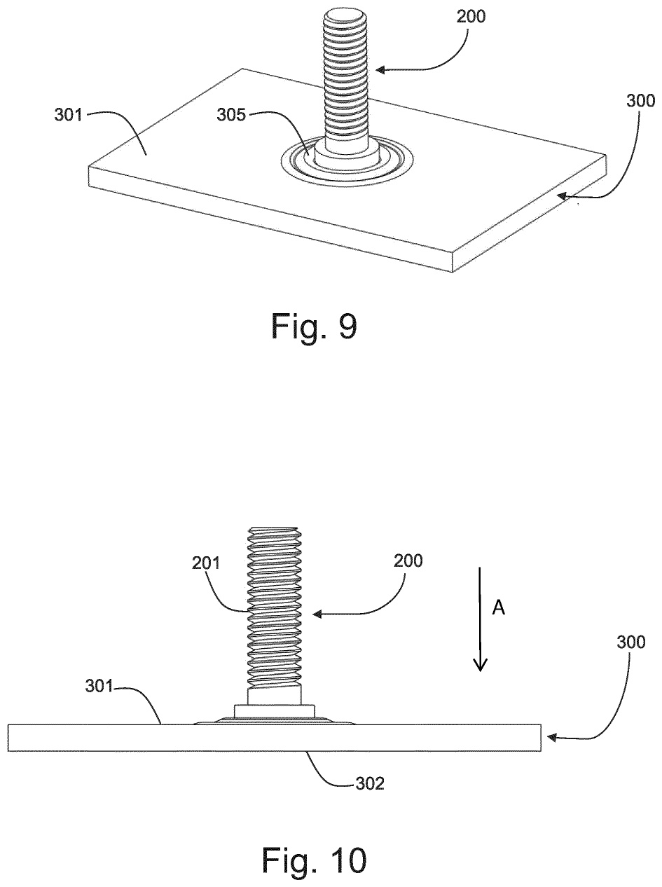

FIGS. 9-11 show the press-fit connection between the fastener 200 and the ductile sheet 300. As mentioned above, it is very important for the application of permanent assembly conditions that there is no protrusion on the underside 302 facing the anvil 400. Another important point is that the process and the finished press-fit connection allows a leak-proof application, especially for closed component spaces where pressurized or non-pressurized gases and liquids are present. Thanks to this permanent press-fit connection, no additional elements such as a gasket or sealant are required, i.e. the press-fit process simplifies production and reduces unit production costs.

FIG. 12 shows an alternative variant of the fastening element 200, which differs from the first variant as explained with respect to FIGS. 1-8 only in that the protrusions formed as anti-rotation elements 205 extend up to the circumferential lateral surface of the shoulder 203. This means that the protrusions are deeper. This achieves improved anti-twist protection.

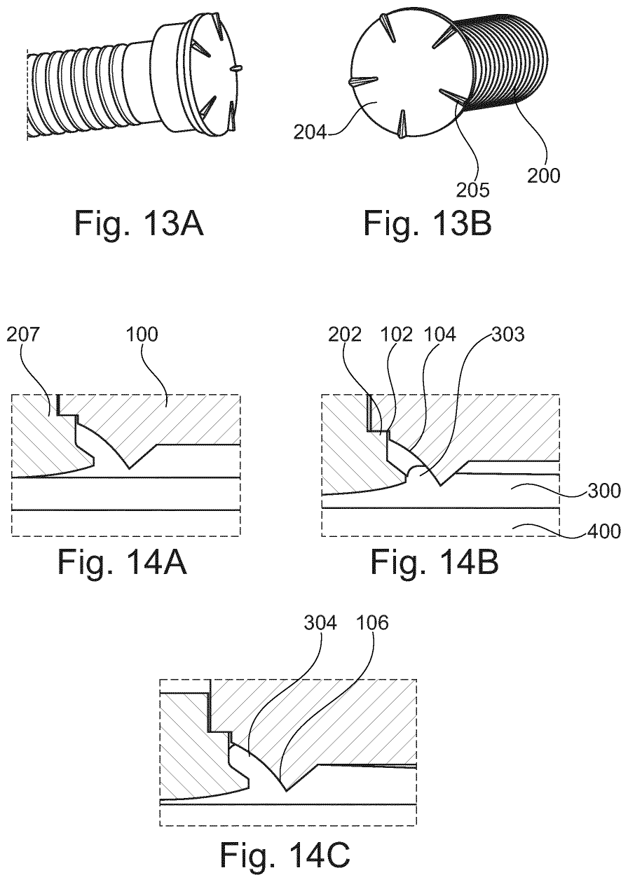

A preferred embodiment of an anti-rotation geometry are ribs as shown in FIGS. 13A, 13B. The ribs 205 extend in a radial direction and are preferably formed uniformly around the circumference immediately adjacent to the head 204. It should be emphasized here that they are formed only in a radially outer portion, so that the central portion projecting in the axial direction A does not have ribs 205 and continues to be the foremost surface portion of the fastener 200. The ribs have a height in the axial direction A that preferably increases radially outwardly. A front end face or end edge of the respective rib 205 preferably extends at an axial height that is recessed with respect to the central region. In this case, the end face of the rib 205 runs horizontally, for example, i.e. perpendicular to the axial direction A. Preferably, all end faces lie within a common plane. The ribs 205 have, for example, a triangular cross-sectional profile. In FIGS. 13A, 13B, 5 ribs 205 are shown as an example. However, there may be more ribs 205 such as 8 to 10 ribs.

The fastening element 200 is preferably used for components 300 made of ductile materials such as aluminum alloys, copper alloys or steels. The fastening element 200 itself is preferably made of steel with a higher strength than the component 300. As a rule, the fastening element 200 is quenched and tempered to a tensile strength of at least 800 N/mm², preferably 1000 N/mm².

The invention is not limited to the embodiment described above. Rather, other variants of the invention can also be derived therefrom by the person skilled in the art without leaving the object of the invention. Furthermore, in particular, all individual features described in connection with the embodiment example can also be combined with each other in other ways without leaving the object of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a press-fit connection between a fastening element and an unpunched component that has not been pretreated by a hole-forming process, the method comprising:
pressing the component against an anvil that has a flat bearing surface on which an underside of the component rests;
providing the fastening element with a head;
pressing, via a punch, the fastening element with the head into the component without piercing the component, wherein an underside of the component is not deformed and wherein material of the component is initially displaced;
pressing at least part of the displaced material radially against the head by the punch so that in an axial direction, a form fit is formed between the material pressed against the head and the head;
pressing a press ring, the punch comprising the press ring, against a press surface formed on the head for transmitting a press-in force; and
pressing the displaced material via a forming section in a radial direction towards the head, wherein the punch further comprises the forming section.

2. The method according to claim 1, wherein the head has a head side oriented toward the component and has a protruding center region, such that the head is initially pressed with the center region against the component and material of the component is displaced radially outward.

3. The method according to claim 1, wherein the head side oriented toward the component is convexly curved.

4. The method according to claim 1, wherein the forming section is conical or curved.

5. The method according to claim 1, wherein the punch forms a cutting ring at its front end with which it cuts into a surface of the component, the forming section adjoining the cutting ring.

6. The method according to claim 1, wherein the fastening element has a shank to which the head adjoins at the end, wherein the head has on its head underside a projecting shoulder that directly surrounds the shank, wherein a radially outwardly projecting pull-out surface adjoins thereto, which in the axial direction is offset with respect to the head side, and wherein the material is pressed only over the pull-out surface in order to form the form fit in the axial direction.

7. The method according to claim 1, further comprising:
exerting a force on the punch;
feeding the punch and fastener to the component while applying the force;
plastically deforming the component by the head of the fastener;
forming a plastically deformed material bead around the head due to the head penetrating the component;
contacting the material bead with the forming section;
displacing material of the material bead toward the pull-out surface and against anti-rotation members using the forming section;
leaving a clearance to a peripheral surface of a shoulder of the head;
overlapping and pressing the material against the pull-out surface to form the form fit acting in the axial direction; and
creating an anti-rotation lock by the anti-rotation elements.

8. A press-fit connection between a fastening element and a component, wherein the component is unpunched and the fastening element is pressed into the component with a head first without piercing the latter, wherein an underside of the component is planar and wherein material displaced by the head during the press-fit operation is reshaped in the radial direction towards the head and forms a form fit with the head.

9. The press-fit connection according to claim 8, wherein the head has a frontal head side with a protruding central region, and/or the component is flat on its underside opposite the fastening element, and/or the head has anti-rotation elements which are formed on an end-face head side of the head in the form of ribs extending in the radial direction.

10. A fastener for a press-fit joint according to claim 8, the fastener comprising a head, the head having a head side with a protruding center portion, wherein the head side has a plurality of anti-rotation elements formed thereon, the anti-rotation elements being formed as ribs or notches and extending in a radial direction.

11. The fastener according to claim 10, wherein 3 to 10 anti-rotation elements are formed on the head side.

12. The fastener according to claim 10, wherein the ribs are formed only in an outer region and do not extend to the center, and wherein a height of the ribs increases with increasing distance from the center.

13. The fastener according to claim 10, wherein an end face of the ribs remote from the head side extends within a common plane and does not protrude beyond the center of the head side.

14. The fastener according to claim 10, wherein the fastener is designed as a bolt-shaped element with a shank, to which the head adjoins at the end, the head having a head underside which is opposite the head side and on which a shoulder is formed which directly adjoins the shank in the radial direction and which forms a pressing surface for transmitting an axial pressing-in force, and wherein the fastener comprises a pull-out surface adjoining the shoulder in the axial and in the radial direction.
